(19) United States
(12) Patent Application Publication
(10) Pub. No.: US 2009/0064008 A1
(43) Pub. Date: Mar. 5, 2009

(54) USER INTERACTION FOR CONTENT BASED STORAGE AND RETRIEVAL

(75) Inventors: Chaojun Liu, Kirkland, WA (US); Luca Rigazio, San Jose, CA (US); Peter Veprek, San Jose, CA (US); David Kryze, Campbell, CA (US); Steve Pearson, Felton, CA (US)

Correspondence Address: GREGORY A. STOBBS, 5445 CORPORATE DRIVE, SUITE 400, TROY, MI, 48098, US

(73) Assignee: MATSUSHITA ELECTRIC INDUSTRIAL CO., LTD., Osaka (JP)

(21) Appl. No.: 11/848,781

(22) Filed: Aug. 31, 2007

(51) Int. Cl. G06F 3/048

(52) U.S. Cl. 715/764

(57) ABSTRACT

A graphic user interface system for use with a content based retrieval system includes an active display having display areas. For example, the display areas include a main area providing an overview of database contents by displaying representative samples of the database contents. The display areas also include one or more query areas into which one or more of the representative samples can be moved from the main area by a user employing gesture based interaction. A query formulation module employs the one or more representative samples moved into the query area to provide feedback to the content based retrieval system.

### FIELD

The present disclosure generally relates to user interfaces for retrieving contents, such as images, stored in a computer readable medium, and relates in particular to user interfaces for use with Content Based Image Retrieval Systems (CBIR).

### BACKGROUND

The statements in this section merely provide background information related to the present disclosure and may not constitute prior art.

Content based image retrieval (CBIR) has been an active research and development area for the past decade, and many CBIR systems have been built. Most CBIR systems use low-level visual features like color, texture and shape to represent all images in the database. During retrieval, a user provides a query image to the system. Typically, the query image is provided by the user either drawing/sketching the image or supplying a sample real image (either a new one or one selected from a database) to the system. Then the system calculates the feature for the query image, compares it with features of the images in the database, and returns to the user a list of most similar images in descending order.

Because of the “semantic gap” between the low-level visual features and the human's perception of images, usually such CBIR systems have poor retrieval performance. A popular method to improve the performance is to ask the user to give feedback to the system. Then the system adjusts the query image, the search metric, or both based on the feedback (in terms of relevance of the returned images to the target image (i.e. the one for which the user is searching)). Based on the adjusted query image and/or adjusted search metric, the system can then re-do the retrieval and hopefully return better images. This process is called relevance feedback.

However, almost all research efforts have been focused on image processing and retrieval technology. Very little attention has been paid to the issue of user interfaces for CBIR systems. One exception is disclosed in Kraft et al. (U.S. Pat. No. 6,938,034). Another exception is disclosed in Liu et al. (U.S. Pat. No. 7,099,860). The disclosures of these issued U.S. patents are incorporated herein in their entirety for any purpose.

### SUMMARY

A graphic user interface system for use with a content based retrieval system includes an active display having display areas. For example, the display areas include a main area providing an overview of database contents by displaying representative samples of the database contents. The display areas also include one or more query areas into which one or more of the representative samples can be moved from the main area by a user employing gesture based interaction. A query formulation module employs the one or more representative samples moved into the query area to provide feedback to the content based retrieval system. A display module receives query results from the content based retrieval system, and displays at least part of the query results in the main area as neutral representative samples.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1A is a graphical representation illustrating a graphic user interface system.

FIG. 1B is a block diagram illustrating display areas of the graphic user interface.

FIGS. 2A-2D are block diagrams illustrating an example of operation of the graphic user interface.

FIG. 3 is a graphical representation illustrating a grouped cluster space.

FIG. 4 is a block diagram illustrating another embodiment of the graphic user interface.

FIG. 5 is a functional block diagram illustrating the graphic user interface system connected to a contents based retrieval system.

FIG. 6 is a flow diagram illustrating a method of operation for a user interface connected to a contents based retrieval system.

### DETAILED DESCRIPTION

The following description is merely exemplary in nature and is not intended to limit the present disclosure, application, or uses.

This description relates to the area of easy content archival and processing combined with tangible user interfaces. An intuitive user interface can enable easy and effective access of contents for Content Based Image Retrieval (CBIR). The described systems and methods can facilitate development of products that simplify the way people store, access and process images and other types of content (e.g., documents, notes) stored in a computer readable medium at home and at work.

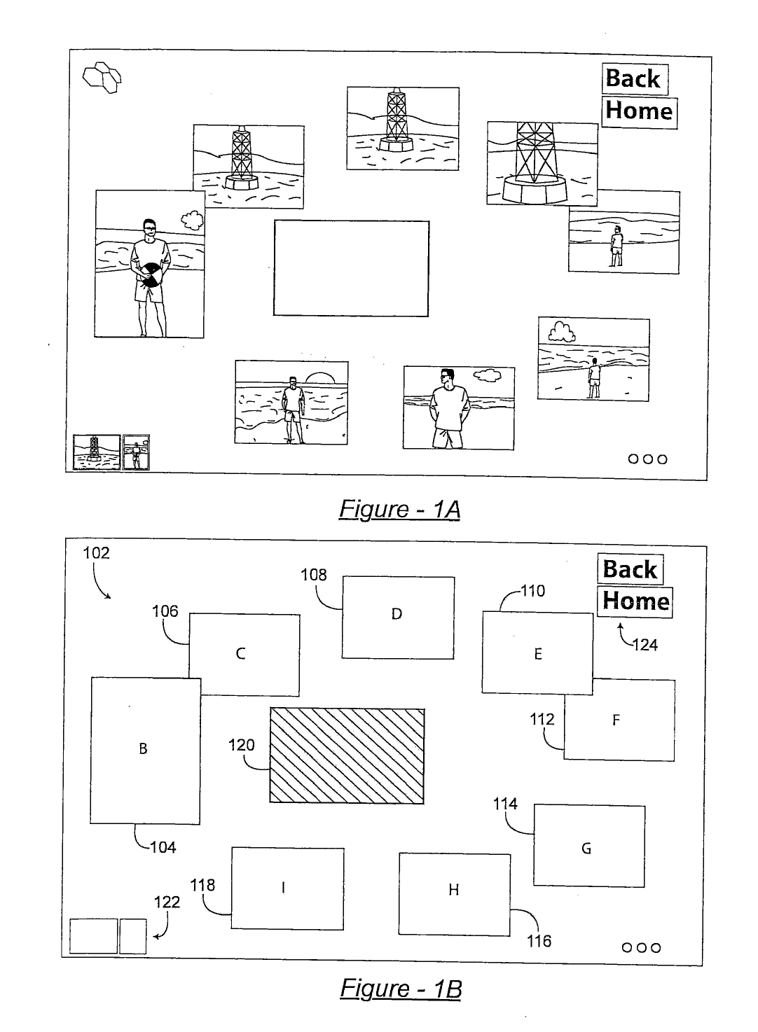

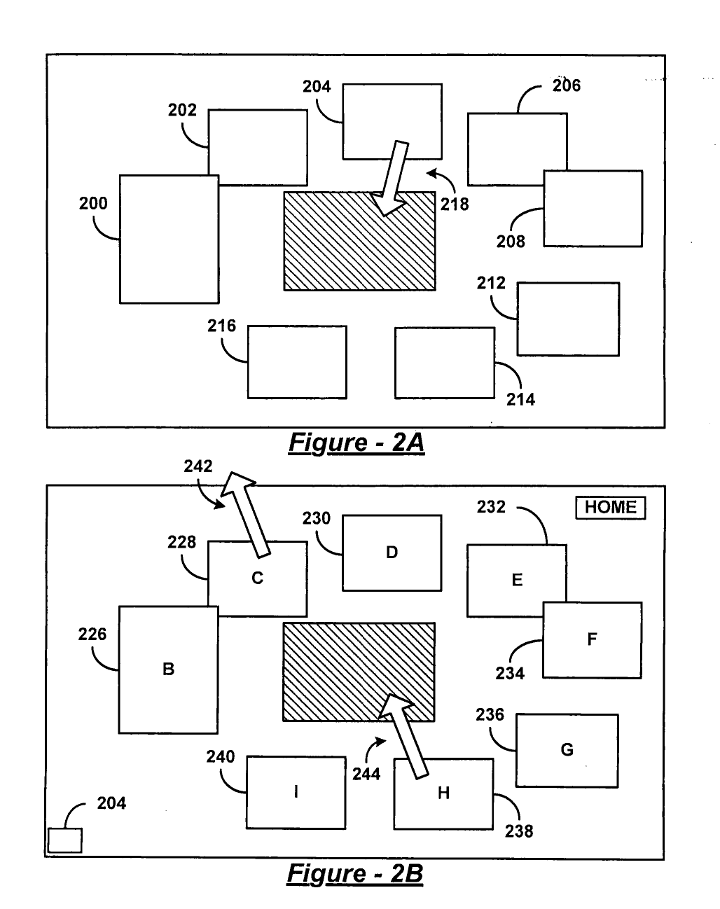

Starting with FIGS. 1A and 1B and referring generally thereto, a new user-interface enables easy user feedback for discriminative content based retrieval. It can be based on any type of display that enables input by gestures (fingers), such as a touch screen display or a surface-scan display. A surface scan display is a display that is also capable of registering information about objects placed on its surface. Other types displays can be used and other types of gestures can alternatively or additionally be supported (e.g., clap, pointing device, accelerometer, etc.).

The graphic user interface 100 can be for any type of content based retrieval system. It can include three areas in the display, and it can support a few gesture based interactions through which the user can easily give the CBIR system relevance feedback.

A main area 102 can display a rough overview of the whole database, such as an image database. For example, the main area 102 can use a few (6-12) representative sample images 104-118 in the database. One way to select the sample images is to group all images in the database into a few (6-12) clusters, based on similarity of the images, using any unsupervised learning algorithm such as K-means algorithm. The image that is closest to the central point of each cluster can be chosen to be the representative sample and is displayed. Alternatively or additionally, the representative sample images can be selected as a number of images closest in similarity to a target sample image.

A query area 120 can be defined, for example, in a center of the display. This query area 120 can be where the query images are placed. Any images put in this area can be used as the query images for the next retrieval (i.e., the CBIR system will search for images that are most similar to these images).

In some embodiments, a backup area 122 can be defined, for example, in a lower left corner of the display. The backup area 122 can allow the user to temporarily put aside images that that the user may want to use later. In some embodiments, users can use gestures to move representative sample images in the main area 102 or in the query area 120 into the backup area 122, or move representative sample images the backup area 122 to the main area 102 or the query area 120. For example, representative sample images selected to be query sample images by user gesture can be added to the backup area 122 automatically. Alternatively or additionally, controls 124 can be provided, for example, in an upper right corner of the display, and these controls 124 can be selected by user gesture in order to return to a previous retrieval result. For example, selection of a control can cause automatic, selective moving of representative sample images in the backup area 122 to the main area 102 and/or query area 120.

In some embodiments, automatic selective moving of representative sample images can be accomplished using a query history. This query history can be used to go back one retrieval at a time. Alternatively or additionally, this history can be used to go back several retrievals.

In some embodiments, all interaction between the user and the system can be through gesture. For example, the user can move images using a finger. By pulling representative sample images from the main area 102 and/or the backup area 122 into the query area 120, the CBIR system can be given positive feedback (i.e. those images are relevant to the target). By pulling images from the main area 102 or the backup area 122 away to the edge or corner of the display, negative feedback can be given to the CBIR system (i.e., those images are non-relevant to the target). It should be readily understood that an initial query can be made by providing positive and/or negative feedback to the system, and that further positive and/or negative feedback can be provided in subsequent turns. It should also be readily understood that some embodiments can require at least one sample image for positive feedback in order to perform the initial query. However, negative feedback can alternatively or additionally be used alone to browse the database by progressive shifting, either in the initial query, subsequent queries, or both.

In additional or alternative embodiments, instead of displaying the retrieved images sequentially in a linear fashion, the images can first be grouped into small clusters (i.e., groups) in which each group has no more than a predetermined number of images. Then, only the representative sample image for each cluster can be displayed. The representative sample image can be the one that is the closest to the query image in that cluster.

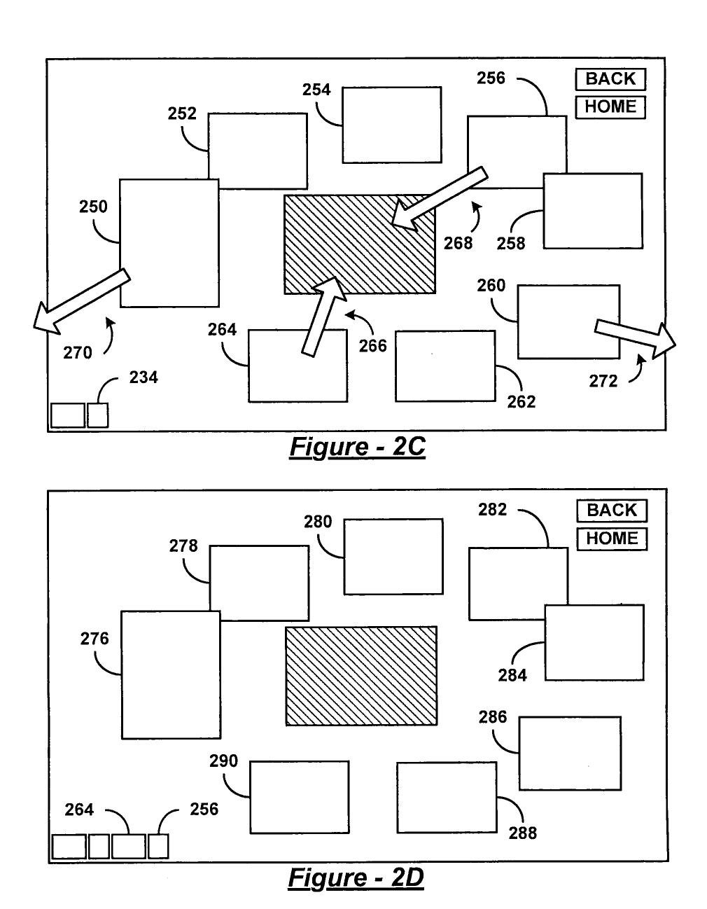

Turning now to FIGS. 2A-2D and referring generally thereto, an example of operation of the graphic user interface system is described. As depicted in FIG. 2A, the graphic user interface system can first display a few images 200-216 in a circle that represents the main area. In this initial overview of database contents, each image can represent a different cluster. The database contents can be either automatically or manually clustered. The user can pull in and out, zoom in and out, or rotate any items easily just by using a finger.

A center square area can be the query area into which the user can pull multiple images. If there is no interaction with the system for a few (say 5) seconds, then images in the query area can be treated as the query (“positive”) images, which means the user is looking for items similar to the query images. In addition, the user can pull images out to an edge or corner of the display to indicate that those images are not what the user is looking for. In other words, those images can be designated as irrelevant (“negative”). The CBIR system can then search the database based on the positive and (optionally) negative images. This graphical user interface system provides a significantly different way to give feedback to CBIR systems. For example, previous user interfaces for CBIR systems have typically asked the user to click checkboxes below each retrieved image to indicate whether it is positive, negative, or neutral.

Movement 218 (FIG. 2A) of a particular representative sample image 204 to the query area can return similar images 226-240 (FIG. 2B) that can be displayed in order according to their similarities to the positive image 204. The returned images 226-240 can be displayed in the main area sequentially, while the representative sample image 204 selected as the query image can be added to the backup area. At this point, the query history can be recorded in a computer readable medium as follows: (image 204).

Retrievals can also be based on dissimilarities to any negative images. For example, movement 242 of image 228 to an edge or corner of the display can cause that image 228 to be used to provide negative feedback to the CBIR system. Then the graphic user interface system can wait until movement 244 of image 238 into the query area provides a query image for positive feedback. After a period of no interaction, the new query can be formulated and provided to the CBIR system, and query results displayed as representative images 250-264 (FIG. 2C). At this point, the query history can be recorded as follows: (image 204+(image 238−image 228)).

Between consecutive retrievals, the user can be permitted to provide multiple images for positive feedback and/or negative feedback for use in a next retrieval. For example, movement 266 of image 264 into the query area can cause that image 264 to be used to provide positive feedback to the CBIR system for the next retrieval. Also, subsequent movement 268 of image 256 into the query area can cause that image 256 to be used to provide positive feedback to the CBIR system for the next retrieval. Additionally, movement 270 of image 250 to an edge or corner of the display can cause that image 250 to be used to provide negative feedback to the CBIR system for the next retrieval. Further, movement 272 of image 260 to an edge or corner of the display can cause that image 260 to be used to provide negative feedback to the CBIR system for the next retrieval. After a period of no interaction, the new query can be formulated and provided to the CBIR system, and query results displayed as representative images 276-290 (FIG. 2D). At this point, the query history can be recorded as follows:

```
(image 204  +
    (
        (image 238 − image 228) +
            ((image 264 + image 256) − (image 250 + image 260))
    )
).
```

It should be readily apparent to one skilled in the art that this query history can be parsed to formulate queries that provide positive and negative feedback to the CBIR system, while also permitting the user to navigate backwards through the query history to return to a previous retrieval state. Alternatively or additionally, the query history can explicitly record each retrieval state.

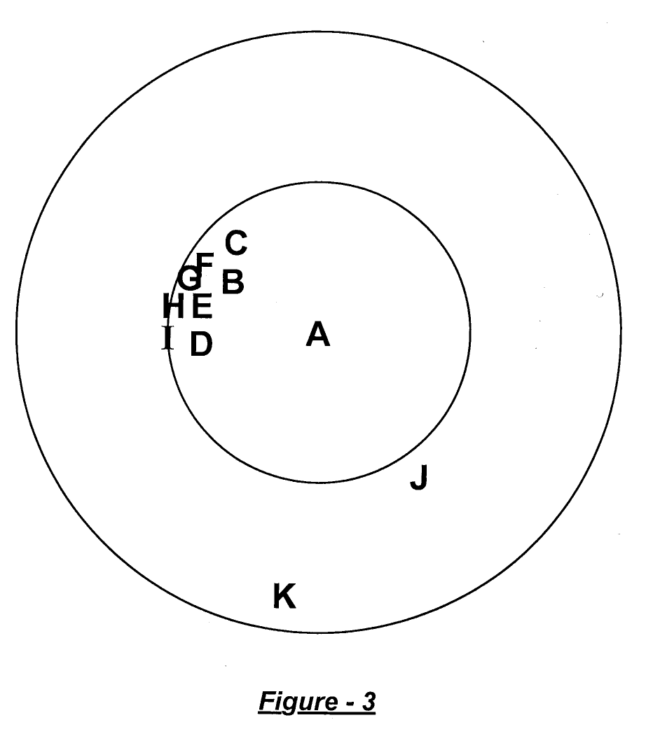

In alternative or additional embodiments, instead of displaying all retrieved items sequentially, they can first be grouped into clusters and one or more representative sample images from the clusters displayed. FIGS. 1B, 3, and 4 illustrate an advantage of this point. For example, suppose the query image is A and the retrieved results are B, C, . . . , K. Suppose also that the user is actually looking for J. As there are so many similar and better matched images (from B to I), direct display of all the retrieved items sequentially, B to I, can take over the entire screen as depicted in FIG. 1B. In this case, J can be over-shadowed and not displayed in the screen, although the distance between J and A is just slightly larger then those from B to I. This type of situation can be very common, especially for a large image database. Failure to display J and other items further away from the target can also deprive the user of opportunities to provide useful feedback.

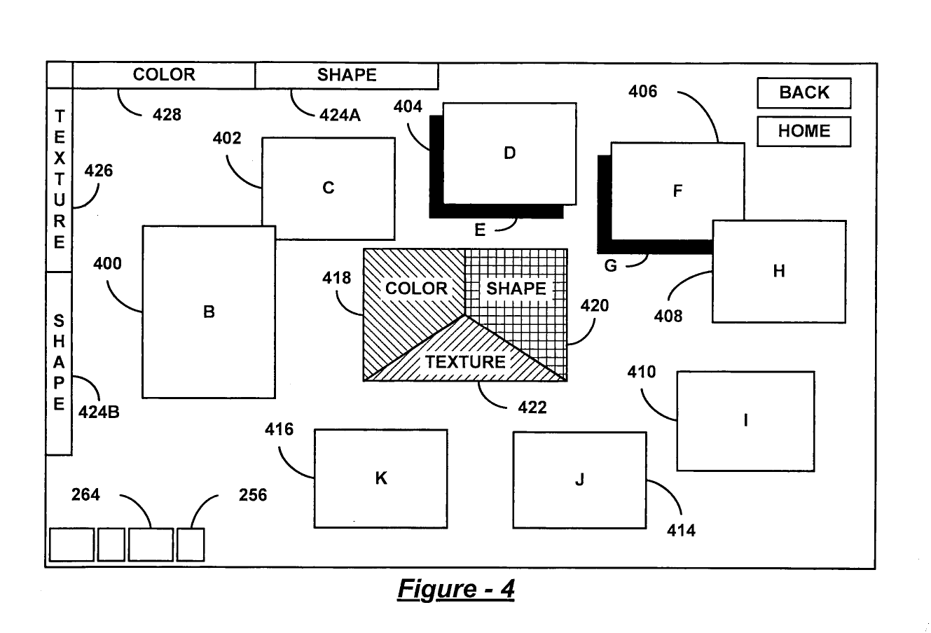

However, if the results are first clustered into groups, B to I can be grouped into one cluster (where B can be the representing image), which is the closest one to the target A, and J can be the second-closest cluster to the target A. In some embodiments, J can be the second image instead of the ninth image in the N-best list and can be displayed. In alternative or additional embodiments, if the user is looking for C, as C is very similar to B, that cluster can be opened by the user to quickly find C. Alternatively or additionally, as depicted in FIG. 4, representative sample images 400-402 and 408-416 in the clusters can be sequentially displayed in combination with representative sample images 404-406 of sub-clusters. These sub-clusters can be formed for clusters containing a comparatively greater number of images. Determination to form sub-clusters can be performed when there are some empty clusters, resulting in available space in the main area, but there are still too many images in the database to display them all. Also, similarity thresholds for performing clustering and/or sub-clustering can be performed dynamically based on numbers of images in the database and/or clusters.

Instead of just displaying one representative image for a cluster, the graphic user interface system can display the clusters in a 3-D fashion, which can look like a stack of pages, where the top image is the representative image for that cluster. Accordingly, the user can easily tell roughly how many images are in each cluster or sub-cluster. The same 3-D display can be performed for the sub-clusters 404-406.

In some embodiments, areas of the display for providing feedback can have regions for specifying how an image moved to one or more of the sub areas is similar to or different from the target image. For example, the query area can be composed of a color region 418, a shape region 420, and a texture region 422. These positive feedback regions can be arranged to be adjacent to one another so that an image can be moved to at least partially intersect only one of the regions, only two of the regions, or all three of the regions. Accordingly, by selectively intersecting an image with these positive feedback regions, the user can specify one, two, or all three criteria as relevant in a positive way to the target image. Similarly, the corner and/or edge of the display can have shape regions 424A and 424B, texture region 426, and color region 428, plus a remainder of the corners and/or edges for specifying all three of these criteria. These negative feedback regions can be arranged to be adjacent to one another so that an image can be moved to at least partially intersect only one or two of the regions. Accordingly, by selectively intersecting an image with these negative feedback regions, the user can specify one, two, or all three criteria as relevant in a negative way to the target image. The query formulated for input to the CBIR system can specify how each of the positive and/or negative feedback images is to be applied in forming the target sample image, and/or the query can specify weights to be applied for the similarity axes of the cluster space with regard to the positive and/or negative feedback images. Alternatively or additionally, the graphic user interface system can apply weights along axes of similarity of a cluster space received as query results from the CBIR system. These weights can thus affect grouping of clusters for selection of representative samples. The information about how each representative sample is similar or different from the target can be recorded in the query history.

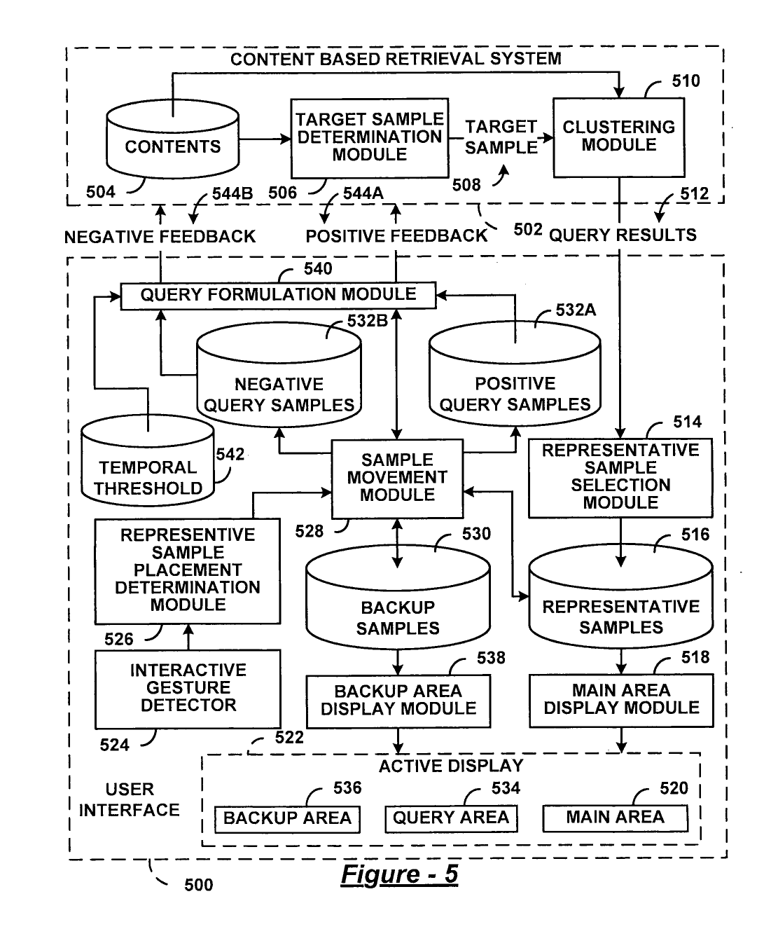

Turning now to FIG. 5, the graphic user interface system 500 is connected to a contents based retrieval system 502. The contents based retrieval system 502 can include a contents datastore 504 that can contain samples. A target sample determination module 506 can access the database 504 and select a random image as an initial target sample 508 for communication to a clustering module 510 in order to supply query results 512 that present an overview of contents of the database 504. Alternatively or additionally, the contents of database 504 can be pre-clustered, and a target sample pre-selected for graphic user interface system initialization. This pre-clustering can be performed, for example, by target sample determination module 506 recursively feeding each instance and/or combinations of instances of database contents to clustering module 510 to measure distribution of the database contents in a cluster space. Then, a target sample 508 formed of one or more instances of database contents can be determined that produces a most even or suitably even distribution of the contents in the cluster space when used as a target sample 508. Alternatively, a target sample 508 formed based on all contents of datastore 504 can be pre-determined.

Graphic user interface system 500 can have a representative sample selection module 514 that receives the query results 512 and selects a number of representative samples. For example, the representative sample selection module 514 can select a predetermined number of contents closest to the target sample, and/or group the clusters and select one or more representative samples from one or more clusters. The clusters can be grouped by a predetermined number of contents in each cluster and/or based on a similarity metric. The selected representative samples can be stored in datastore 516. Main area display module 518 can access the datastore 516 and display the representative samples in a main area 520 of an active display 522.

Interactive gesture detector 524 can detect one or more types of gestures of a user, and representative sample determination module 526 can distinguish gestures that indicate movement of representative samples from one area of the display 522 to another. Upon movement of a representative sample from one area of the display to another, a sample movement module 528 in communication with module 526, can rearrange storage of representative samples accordingly. For example, representative samples can be exchanged between the representative samples datastore 516, a backup samples datastore 530, and positive and negative query samples datastores 532A and 532B. Backup area display module 538 can continuously display contents of dastore 530 in the backup area 536, as module 518 can continuously display contents of datastore 516 in the main area 520.

Module 528 can exchange contents of datastores 516, 530, 532A, and/or 532B in response to various types of gestures and in a number of ways. For example, module 528 can exchange contents of datastores 516, 530, 532A, and/or 532B when a gesture indicates pulling by touch or other gesture of a sample from the main area 520 to a query area 534 and/or the backup area 536, from the backup area 536 to the main area 520 and/or the query area 534, and/or from the query area 534 to the main area 520 and/or the backup area. Alternatively or additionally, module 528 can exchange contents of datastores 516, 530, 532A, and/or 532B when the gesture indicates user selection of a control for backing up to a previous retrieval state specified by a query history stored in datastores 532A and 532B. Alternatively or additionally, module 528 can respond to a notification from a query formulation module 540 that a query has been completed, and this response can include copying newly added positive query samples to backup datastore 530.

Query formulation module 540 can form the query by continuously or periodically accessing databases 532A and 532B. If at least one new query sample has been added, and if a temporal threshold 542 has been exceeded without addition of any more samples to datastores 532A and 532B, then module 540 can formulate the query and communicate it to contents based retrieval system 502 as positive feedback 544A and negative feedback 544B. Content based retrieval system 502 can then employ the feedback to execute formulation of the target sample 508 and/or the query results 512 during a next retrieval.

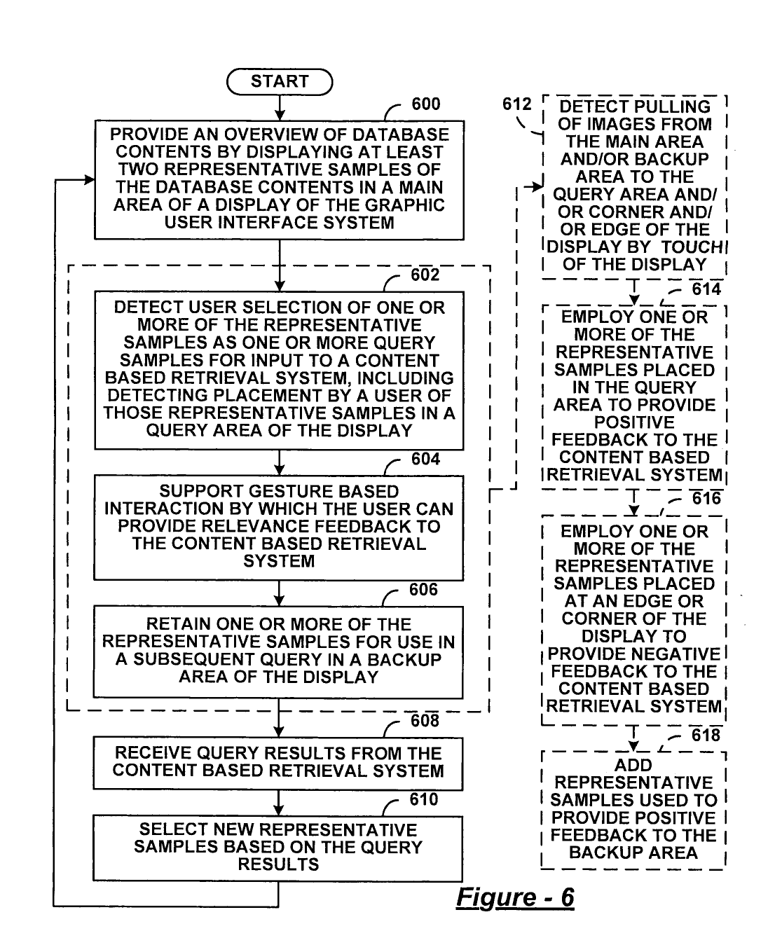

Turning now to FIG. 6, a method of operation for a graphic user interface system for use with a content based retrieval system includes providing an overview of database contents at step 600 by displaying at least two representative samples of the database contents in a main area of a display of the graphic user interface system. User selection of one or more of the representative samples as one or more query samples for input to the content based retrieval system can next be detected at step 602, including detecting placement by a user of those representative samples in a query area of the display. Gesture based interaction can be supported at step 604 by which the user can provide relevance feedback to the content based retrieval system. Once query results are received from the content based retrieval system at step 608, new representative samples can be selected at step 610. Processing can then return to step 600, at which point display of the new representative samples provides a new and different overview of the database contents.

In some embodiments, one or more of the representative samples can be retained at step 606 for use in a subsequent query in a backup area of the display. In alternative or additional embodiments, steps 602-606 can be accomplished at least in part by steps 612-618 For example, allowing the user at step 612 to move one or more of the representative samples from at least one area of the display to another can be accomplished in a number of ways. The samples can be moved, for example, by detecting user touch pulling the samples toward the query area at center of the display and/or to an edge or corner of the display. Alternatively or additionally, in step 612, the movement can be accomplished by allowing the user to place one or more of the representative samples from the backup area into one or more of the main area and the query area. In some embodiments, this placement can be detected by the user pulling the samples from one area to another. In alternative or additional embodiments, user selection of a control can cause movement of samples from one area to another.

The representative samples placed in the query area can be employed at step 614 to provide positive feedback to the content based retrieval system. Additionally or alternatively, representative samples placed at an edge or corner of the display can be employed at step 616 to provide negative feedback to the content based retrieval system. Representative samples employed to provide feedback, such as positive feedback, can be added to the backup area at step 618.

One skilled in the art can readily recognize that the graphic user interface system and method is a significant advance for content based retrieval systems. For example, no learning curve is needed to operate the device, as the interface is very intuitive and straightforward. It mimics the capabilities employed by people interacting with physical images, documents, etc. in the physical world. In particular, some embodiments allow the user to pull similar samples by dragging them into the center and throw away irrelevant ones by pulling them out of sight. Also, these and perhaps all interactions can be performed just by gestures, so that there is no need to use any keyboard. Additionally, displaying the retrieved results by clusters enables the user to quickly have an overview of the results. Moreover, in embodiments having a backup area, users are allowed to put aside query results for later use. This capability can be very useful, for example, because the user is not necessarily looking for only one type of images. The user's interest may change during retrieval. This behavior is known as berry picking and can be very common.

What is claimed is:

1. A graphic user interface system for use with a content based retrieval system, the graphic user interface system comprising:
an active display having a plurality of display areas, including:
(a) a main area providing an overview of database contents by displaying a plurality of representative samples of the database contents;
(b) at least one query area into which at least one of the plurality of representative samples can be moved at least from said main area by a user employing gesture based interaction; and
a query formulation module employing the at least one representative sample moved into the at least one query area to provide feedback to said content based retrieval system.

2. The graphic user interface system of claim 1, wherein said plurality of display areas further includes a backup area in which at least one of the representative samples can be retained for use in a subsequent query.

3. The graphic user interface system of claim 2, wherein said graphic user interface system allows the user: (a) to place at least one of the representative samples from at least one of said main area or said query area into said backup area; and (b) to place at least one of the representative samples from said backup area into at least one of said main area or said query area.

4. The graphic user interface system of claim 3, wherein said backup area retains representative samples placed therein at least until after a next retrieval performed by said content based retrieval system.

5. The graphic user interface system of claim 1, wherein said representative samples are selected by grouping all contents in the database into a number of clusters based on similarity of the contents to the at least one query samples.

6. The graphic user interface system of claim 5, wherein the clusters are formed using an unsupervised learning algorithm.

7. The graphic user interface system of claim 6, wherein the unsupervised learning algorithm is a K-means algorithm.

8. The graphic user interface system of claim 5, wherein contents closest to central points of each cluster are selected as the representative samples.

9. The graphic user interface system of claim 1, wherein placement of the at least one representative sample in said query area causes the representative sample placed in the query area to be employed as at least one query sample during a next retrieval performed by said content based retrieval system.

10. The graphic user interface system of claim 9, wherein said content based retrieval system performs the next retrieval by searching for contents in the database that are most similar to the at least one query sample.

11. The graphic user interface system of claim 1, wherein all interaction between the user and said graphic user interface system is performed through at least one gesture.

12. The graphic user interface system of claim 1, further comprising at least one display module at least including a main area display module receiving query results from said content based retrieval system, and displaying at least part of the query results in said main area as new representative samples.

13. The graphic user interface system of claim 1, wherein the user can move the representative samples from at least one of said areas to at least one other of said areas by touching a display of the graphic user interface system at a set of coordinates of the display at which the representative samples are displayed, and then moving the representative samples from the one of said areas to the other of said areas by drag and drop.

14. The graphic user interface of claim 13, wherein moving the at least one of said representative samples from said main area to said at least one query area provides positive feedback to said content based retrieval system.

15. The graphic user interface of claim 14, wherein pulling the at least one representative sample from said main area to at least one of an edge or corner of the display provides negative feedback to said content based retrieval system.

16. The graphic user interface of claim 1, wherein said at least one query area includes a positive feedback query area and a negative feedback query area, said query formulation module: (a) employs representative samples moved into the positive feedback query area to provide positive feedback to said content based retrieval system; and (b) employs representative samples moved into the positive feedback query area to provide negative feedback to said content based retrieval system.

17. The graphic user interface system of claim 16, further comprising a display module displaying the positive feedback query area in a center of the active display.

18. The graphic user interface system of claim 17, wherein said query formulation module employs at least one of an edge or corner of the display as the negative feedback query area.

19. The graphic user interface system of claim 16, wherein said query formulation module employs at least one of an edge or corner of the display as the negative feedback query area.

20. The graphic user interface system of claim 1, wherein said query formulation module employs the at least one representative sample moved into the at least one query area to provide positive feedback to said content based retrieval system.

21. The graphic user interface system of claim 1, wherein said query formulation module employs the at least one representative sample moved into the at least one query area to provide negative feedback to said content based retrieval system.

22. The graphic user interface system of claim 1, wherein placement of the at least one representative sample into said at least one query area causes those representative samples to be employed as query samples for a next retrieval performed by said content based retrieval system.

23. A method of operation for a graphic user interface system for use with a content based retrieval system, the method comprising:
providing an overview of database contents by displaying at least two representative samples of the database contents in a main area of an active display;
detecting user movement by gesture based interaction of at least one of the representative samples from at least the main area to a query area of the active display; and
employing the at least one representative sample moved into the at least one query area to provide feedback to the content based retrieval system.

24. The method of claim 23, wherein detecting user movement by gesture based interaction of the at least one of the representative samples includes: (a) detecting user movement of at least one of the representative samples from the main area to a positive feedback query area; and detecting user movement of at least one of the representative samples from the main area to a negative feedback query area, and employing the at least one representative sample moved into the at least one query area to provide feedback to the content based retrieval system includes: (a) employing representative samples moved into the positive feedback query area to provide positive feedback to the content based retrieval system; and (b) employing representative samples moved into the positive feedback query area to provide negative feedback to the content based retrieval system.

25. The method of claim 24, further comprising displaying the positive feedback query area in a center of the active display.

26. The method of claim 25, further comprising employing at least one of an edge or corner of the display as the negative feedback query area.

27. The method of claim 24, wherein said query formulation module employs at least one of an edge or corner of the display as the negative feedback query area.

28. The method of claim 23, further comprising employing the at least one representative sample moved into the at least one query area to provide positive feedback to the content based retrieval system.

29. The method of claim 23, further comprising employing the at least one representative sample moved into the at least one query area to provide negative feedback to the content based retrieval system.

30. The method of claim 23, further comprising:
receiving query results from said content based retrieval system; and
displaying at least part of the query results in said main area as new representative samples.

31. The method of claim 23, further comprising retaining at least one of the representative samples for use in a subsequent query in a backup area of the display.

32. The method of claim 23, further comprising selecting the at least two representative samples by grouping all contents in the database into a number of clusters based on similarity of the contents to the at least one query sample.

33. The method of claim 23, further comprising:
detecting user touch of the active display of the graphic user interface system at a set of coordinates of the at least one representative sample is displayed;
detecting movement by the user of the at least one representative sample displayed at the coordinates into the at least one query area by drag and drop; and
moving the at least one representative sample from the main area containing the set of coordinates into the query area in response to drag and drop by the user of the at least one representative sample into the at least one query area.
